(19) United States
(12) Patent Application Publication
(10) Pub. No.: US 2010/0161550 A1
(43) Pub. Date: Jun. 24, 2010

(54) FILE SYNCHRONIZATION BASED ON INTERCEPTING FILE SYSTEM CALLS

(75) Inventors: Lin Jiang, Cupertino, CA (US); Shoujin Wang, Sunnyvale, CA (US); Dong Chen, Sunnyvale, CA (US); Longlong Wang, Cupertino, CA (US)

Correspondence Address: SCHWEGMAN, LUNDBERG & WOESSNER, P.A., P.O. BOX 2938, MINNEAPOLIS, MN, 55402, US

(73) Assignee: Cisco Technology, Inc., San Jose, CA (US)

(21) Appl. No.: 12/340,301

(22) Filed: Dec. 19, 2008

(51) Int. Cl. G06F 17/30

(52) U.S. Cl. 707/610; 707/E17.005

(57) ABSTRACT

A method is provided for synchronizing file objects between different data centers. Here, a file system call from a virtual file system is intercepted. This file system call is associated with a file object at a data center, which is in communication with a remote data center. The intercepted file system call is then transmitted to the remote data center to synchronize a copy of the file object at the remote data center with the file object at the data center.

### FIELD

The present disclosure relates generally to file access. In an example embodiment, the disclosure relates to file synchronization based on intercepting file system calls.

### BACKGROUND

When files are shared with a large number of users, the files are typically stored in multiple data centers, which allow the files to be shared with other software applications and users. The deployment of multiple data centers to store files provides increased accessibility of the files by, for example, increasing access availability. Data centers are also used for off-site backups where, for example, if one data center fails, then the identical files stored at the other data centers may be used to recover the lost files.

A disadvantage of having the files stored in two or more separate data centers is that the files need to be synchronized. If the files are not synchronized, then the files are not identical and may result in erroneous operations from software applications that depend on the files. Currently, files are synchronized by scanning all the files in one data center to identify changes to the files and then making the changes to copies of the files stored in other data centers. However, the files may become inconsistent during the scan and the scan may take a long period of time.

### BRIEF DESCRIPTION OF DRAWINGS

The present disclosure is illustrated by way of example and not limitation in the figures of the accompanying drawings, in which like references indicate similar elements and in which:

FIG. 1 depicts a diagram of a system, in accordance with an example embodiment, for synchronizing files between two data centers;

FIG. 2 depicts a block diagram of the modules, in accordance with an illustrative embodiment, included in an apparatus that is configured to synchronize file objects between data centers;

FIG. 3 depicts a flow diagram of a general overview of a method, in accordance with an illustrative embodiment, for synchronizing file objects between data centers;

FIG. 4 depicts a block diagram of a high-level architecture of file system related components, in accordance with an embodiment, for intercepting and transmitting file system calls to a remote data center;

FIG. 5 depicts a flow diagram of a general overview of a method, in accordance with an embodiment, for applying file system calls received from a remote data center;

FIG. 6 depicts a block diagram of a high-level architecture of file system related components, in accordance with an embodiment, for receiving file system calls from remote data centers and applying the file system calls; and

FIG. 7 is a block diagram of a machine in the example form of a processing system within which a set of instructions, for causing the machine to perform any one or more of the methodologies discussed herein, may be executed.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

Overview

A method is provided for synchronizing file objects between different data centers. Here, a file system call from a virtual file system is intercepted. This file system call is associated with a file object at a data center, which is in communication with a remote data center. The intercepted file system call is then transmitted to the remote data center to synchronize a copy of the file object at the remote data center with the file object at the data center.

Example Embodiments

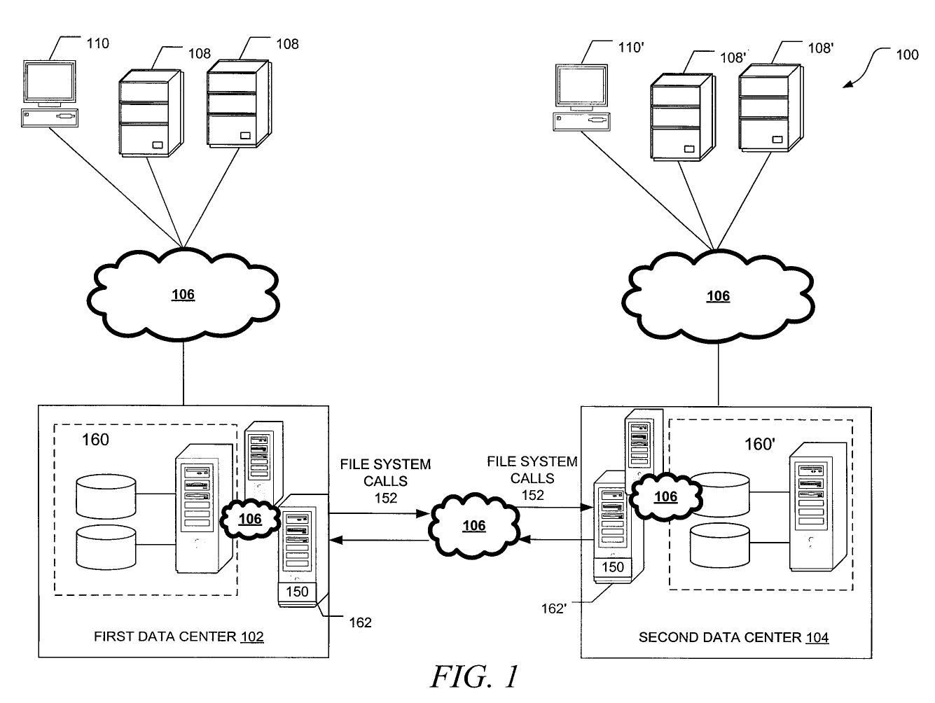

FIG. 1 depicts a diagram of a system 100, in accordance with an example embodiment, for synchronizing files between two data centers 102 and 104. The system 100 includes a first data center 102, a second data center 104, and processing systems, such as client computers 110 and 110′ and servers 108 and 108′, that can access either the first data center 102 or the second data center 104 through a computer network 106. It should also be noted that the first data center 102 and the second data center 104 may also be in communication with each other by way of the computer network 106. Additionally, processing systems associated with each data center 102 or 104 may be in communication with each other by way the computer network 106. In general, the computer network 106 is a collection of interconnected processing systems that communicate utilizing wired or wireless mediums. Examples of such interconnected processing systems include the client computers 110 and 110′, the servers 108 and 108′, the data centers 102 and 104, application servers 162 and 162′, storage systems 160 and 160′, network switches, network routers, and network hubs. Examples of computer networks, such as computer network 106, include Local Area Networks (LANs) and Wide Area Networks (WANs) (e.g., Internet).

A “data center,” as used herein, refers to a processing system or a group of interconnected processing systems. In an example, a data center is a storage system, which is described in more detail below. In another example, the data center may be a facility equipped with or connected to one or more processing systems and associated components, such as computer systems and telecommunications equipment. In the example of FIG. 1, the first data center 102 and the second data center 104 include or encompass application servers 162 and 162′, storage systems 160 and 160′, and other computer systems, such as Web servers and mail servers (not shown). Generally, an application server (e.g., application servers 162 and 162′) is a server that is designed for or dedicated to running specific software applications. An example of an application server is a server that is configured to handle application operations between users and an organization's backend business applications or databases.

A storage system (e.g., storage systems 160 and 160′) generally refers to one or more processing systems that provide a storage service associated with the organization of information on writable, persistent storage devices, such as hard drives, non-volatile memories, tapes, and optical media. Each storage system 160 or 160′ can be deployed, for example, within a Network Attached Storage (NAS) system. In a NAS system, for example, the storage systems 160 and 160′ may be embodied as a file server that is preconfigured to share files according to a client/server model of information delivery to thereby allow multiple client processing systems (e.g., client computers 110 and 110′ and servers 108 and 108′) to access shared files. The NAS system can be deployed over the computer network 106 such that the clients 108, 108′, 110, and 110′ and other processing systems can communicate with the file server by exchanging discrete frames or packets of data according to predefined protocols, such as Transmission Control/Internet Protocol (TCP/IP).

In the example of FIG. 1, the storage system 160 at the first data center 102 is configured to store files that are accessible by, for example, client processing systems 108 and 110 and application server 162. Copies of the same files are also stored in the storage system 160′ at the second data center 104, and are accessed by another set of client processing systems 108′ and 110′. The same files are stored in both the first data center 102 and the second data center 104 because, for example, the additional second data center 104 can increase the accessibility of the files and may also be used for off-site backups.

In some embodiments, the processing systems that access the storage systems 160 and 160′, such as application servers 150 and 150′, that are configured to host capture modules 150 and 150′ that intercept file system calls 152 from a kernel of an operating system that are destined to either storage systems 160 or storage system 160′. As explained in more detail below, these file system calls 152 may then be communicated between the first data center 102 and the second data center 104 to synchronize the files at the data centers 102 and 104 such that the files match.

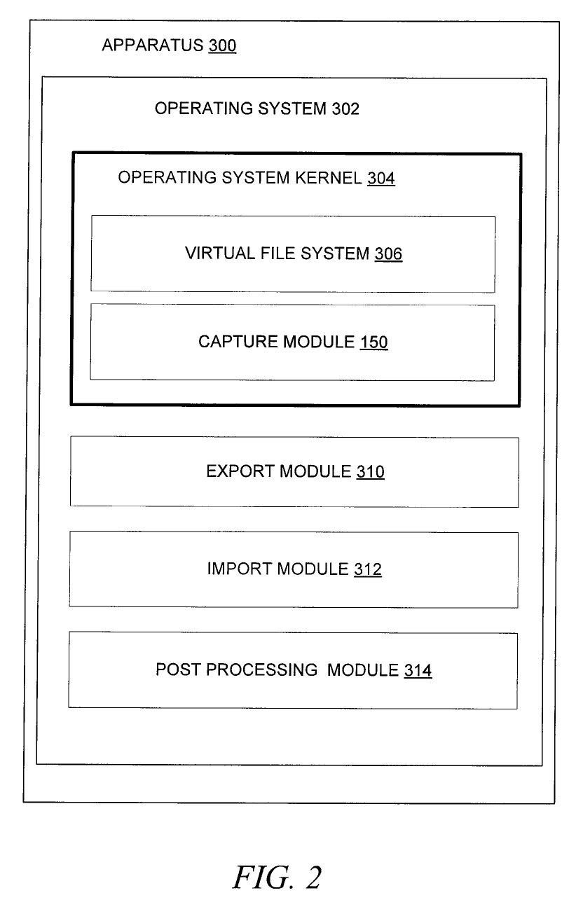

FIG. 2 depicts a block diagram of modules 150, 310, 312, and 314, in accordance with an illustrative embodiment, included in an apparatus 300 that is configured to synchronize file objects between data centers. It should be appreciated that the apparatus 300 may be deployed in the form of a variety of processing systems, such as personal computers, laptop computers, personal digital assistants, server computers, or other processing systems. In an embodiment, the apparatus 300 may form a part of the application server 162 (or other servers) included in the first data center 102 of FIG. 1. In various embodiments, the apparatus 300 may be used to implement computer programs, logic, applications, methods, software, or processes to synchronize file objects between data centers, as described in more detail below.

As depicted in FIG. 2, the apparatus 300 executes an operating system 302 that manages the software processes and/or services executing on the apparatus 300. These software processes and/or services may include an operating system kernel 304, an export module 310, an import module 312, and a post processing module 314. The operating system kernel 304 is a central component of the operating system 302 that, for example, manages the resources of the apparatus 300 (e.g., the communication between hardware and software components) and provides the lowest-level abstraction layer for the resources (e.g., memory, processors and input/output (I/O) devices).

In the example of FIG. 2, the operating system kernel 304 includes a virtual file system 306 and a capture module 150. In general, a file system is an organization of data and metadata on a storage system. Examples of file systems include Ex2, Journaled File System (JFS), Microsoft Disk Operating System (MS-DOS), and MINIX. A “virtual file system,” as used herein, refers to a software abstraction layer above one or more underlying file systems and, for example, serves as an interface between the operating system kernel 304 and the file systems. As explained in more detail below, the virtual file system 306 serves as a root level of a file system interface and, for example, allows applications to uniformly access different types of file systems.

The capture module 150 is included in the operating system kernel 304 such that it can intercept file system calls from or called by the virtual file system 306. A “file system call,” as used herein, refers to a command or procedure associated with the access of file objects. A file object refers to a variety of objects that are associated with a file system, such as superblocks, inodes, dentries, and files. A superblock is at a root of a file system and this superblock describes and maintains a state for the file system. An inode is a data structure in a file system that stores metadata or information about files, directories, or other file objects. Alternatively, an inode can also represent an object in file system, such as a file, a directory, a symbolic link, or other objects. A dentry is another type of data structure in a file system that can be used to translate between names and inodes. In addition, a dentry also maintains relationships between directories and files for traversing a file system.

In view of the different types of file objects, examples of file system calls include superblock operations and inode operations, such as open, write, read, close, and delete operations associated with file objects. Particular examples of file system calls include a deletion of a file, a write to a file, a creation of a file, a creation of a directory, a deletion of a directory, a read from a file, a retrieval of file attributes, and other file system calls.

The export module 310 and the import module 312 are configured to transmit file system calls and to receive file system calls, respectively, from other apparatuses associated with remote data centers. The post processing module 314, as explained in more detail below, is configured to apply the file system calls based on one or more pre-defined policies. It should be appreciated that in other embodiments, the apparatus 300 may include fewer, more, or different modules apart from those shown in FIG. 2. For example, in an alternative embodiment, the export module 310 and the import module 312 may be merged into one module.

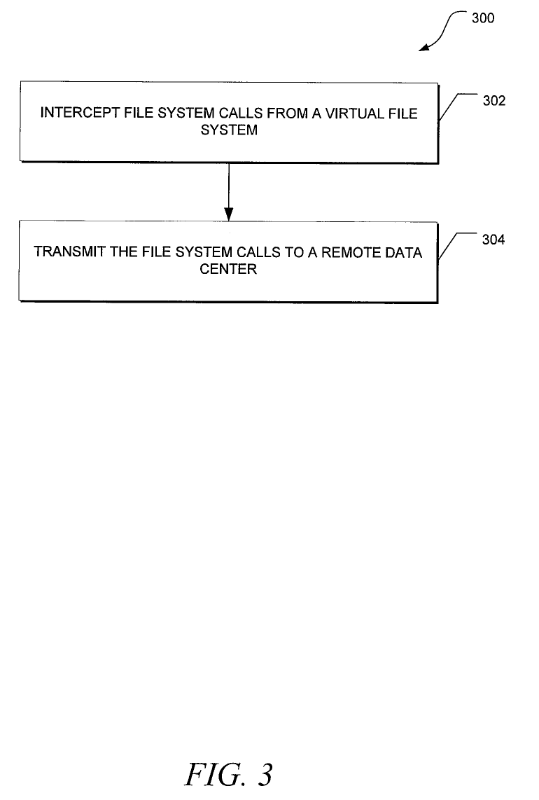

FIG. 3 depicts a flow diagram of a general overview of a method 300, in accordance with an illustrative embodiment, for synchronizing file objects between data centers. In an embodiment, the method 300 may be implemented by the capture module 150 and the export module 310 and employed in the apparatus 300 of FIG. 2. As depicted in FIG. 3, file system calls from a virtual file system are intercepted at 302. As an example, the virtual file system can receive commands from applications to operate on files stored at a data center and can then translate these commands into file system calls that are operable on one or more file systems. In an embodiment, a capture module can intercept such file system calls within a kernel of an operating system. As used herein, the “interception” of file system calls refers to copying or recording of file system calls intended for a file system without affecting the routing of the file system calls to the file system.

As depicted at 304, after the file system calls are intercepted, they are transmitted to a remote data center. For example, the capture module intercepts the file system calls and then forwards the file system calls to an export module. The export module then transmits the file system calls in a message to a remote data center that is configured to store copies of the same file objects. As explained in more detail below, such file system calls are applied to copies of the file objects such that the same file system calls are applied to both copies of the file objects stored at separate data centers.

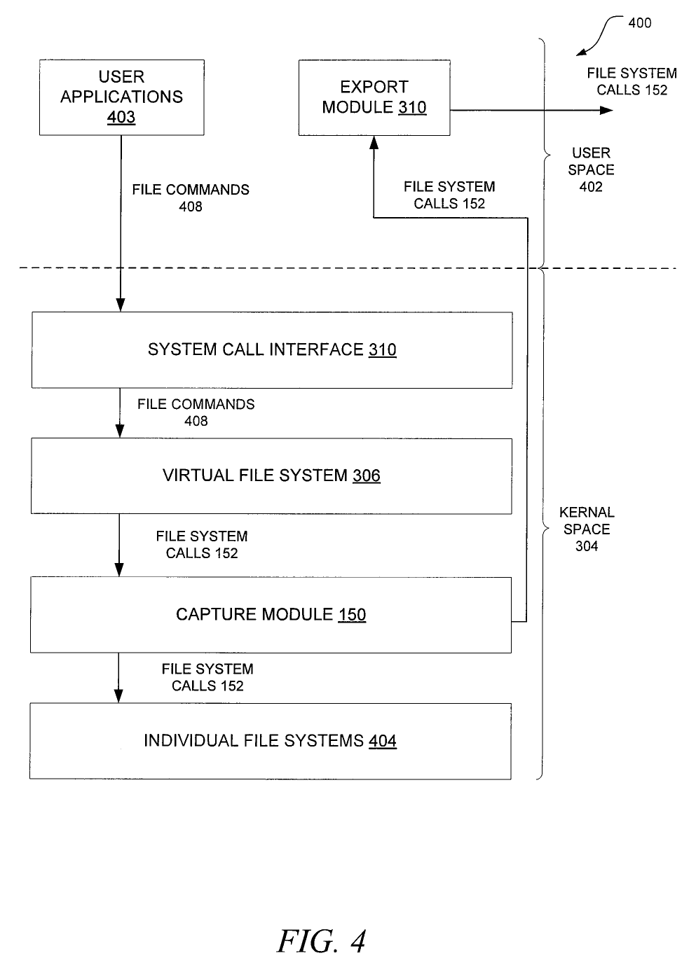

FIG. 4 depicts a block diagram of a high-level architecture 400 of file system related components, in accordance with an embodiment, for intercepting and transmitting file system calls to a remote data center. The architecture 400 may be divided into a user space 402 and a kernel space 304. The user space 402 includes user applications 403 and an export module 310. The kernel space 304 includes a system call interface 310, a virtual file system 306, a capture module 150, and individual file systems 404. It should be noted that the kernel space 304 is a kernel of an operating system (or operating system kernel) and, as used herein, the terms “kernel space” and “kernel” may be used interchangeably.

The user applications 403 may transmit file commands 408 to operate on file objects associated with one or more individual file systems 404. The system call interface 310 serves as a switch, funneling commands (e.g., file commands 408) from the user space 402 to the appropriate endpoints in the kernel space 304.

As explained above, the virtual file system 306 serves as a software abstraction layer above the underlying individual file systems 404. In the example of FIG. 4, the virtual file system 306 can export a set of interfaces and then abstracts them to the individual file systems 404, which may function very differently from one another. Here, each individual file system implementation exports a common set of interfaces that are used by the virtual file system 306. Additionally, the virtual file system 306 can keep track of the currently supported individual file systems 404, as well as other mounted file systems.

The capture module 150 is configured to intercept file system calls 152 called by the virtual file system 306 that are destined to the individual file systems 404. Furthermore, the capture module 150 is configured to transmit the intercepted file system calls 152 to the export module 310. In turn, the export module 310 transmits the file system calls 152 in a message to a remote data center. In an alternate embodiment, the export module 310 may also attach a value to each file system call or the message itself. This value, as explained in more detail below, can be used to resolve conflicts between file system calls operating on the same file object.

It should be appreciated that the actual files (a type of file object) are also intercepted by the capture module 150 and, if needed, transmitted to a remote data center by way of the export module 310. The files are transmitted when the file system calls require such files. For example, if the file system call is for the creation of a file at a data center, then this corresponding file is also transmitted to the other remote data center such that both data centers have identical copies of the same file. Another file system call that requires the file to be transmitted is the modification or update of a file, where an old file at the remote data center is replaced with a newer file.

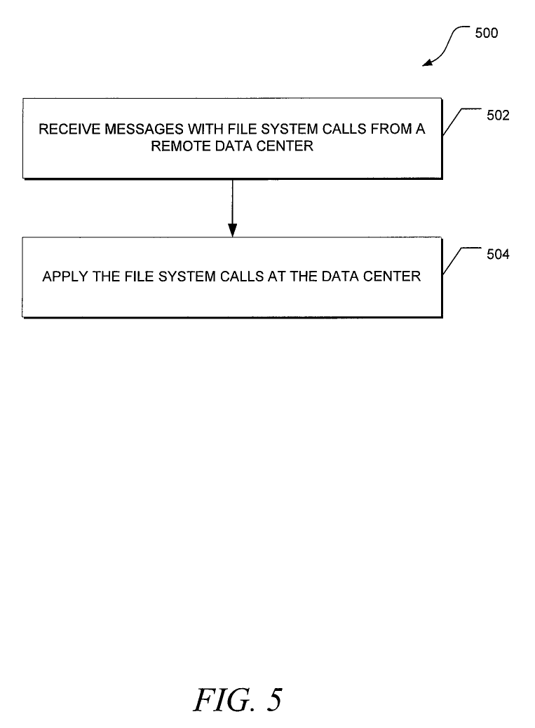

FIG. 5 depicts a flow diagram of a general overview of a method 500, in accordance with an embodiment, for applying file system calls received from a remote data center. In an embodiment, method 500 may be implemented by the import module 312 and the post processing module 314 and employed in the apparatus 300 of FIG. 2.

As depicted in FIG. 5, messages that include file system calls are received at 502 from a remote data center and such file system calls may then be applied at 504. For example, an import module receives file system calls in a message from a remote data center and forwards the file system calls to a post processing module. The post processing module then applies the file system calls and, depending on the type of file system call, it may apply the file system call to a copy of the file object stored at the data center or apply the file system call by creating a copy of the file object at the data center. For example, the application of file system calls may include a deletion of a file or directory at the data center. In another example, the application of file system calls may include the creation or modification of a file at the data center. As a result of the application of identical file system calls to all interconnected data centers, the file objects at these data centers can be synchronized.

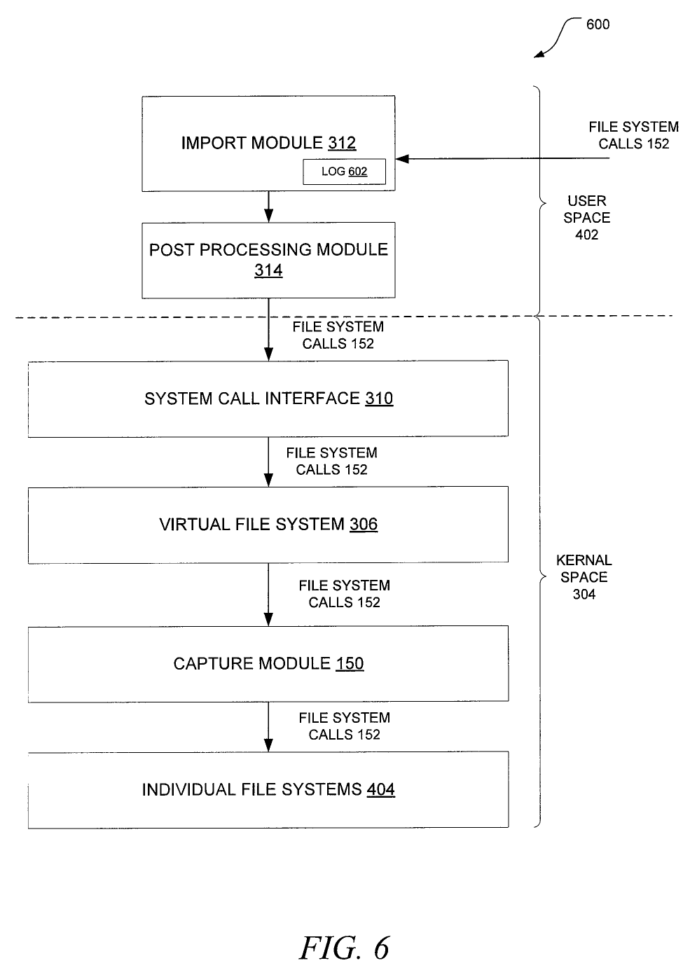

FIG. 6 depicts a block diagram of a high-level architecture 600 of file system related components, in accordance with an embodiment, for receiving file system calls from remote data centers and applying the file system calls. The architecture 600 is divided into a user space 402 and a kernel space 304. The user space 402 includes an import module 312 and a post processing module 314. The kernel space 304 includes a system call interface 310, a virtual file system 306, a capture module 150, and individual file systems 404, which are explained above.

The import module 312 is configured to receive messages from other remote data centers, and these messages include file system calls 152 and also files associated with the file system calls. In an embodiment, the import module 312 identifies or extracts the file system calls from the messages and forwards the file system calls 152 and files, if applicable, to the post processing module 314.

In an alternative embodiment, the import module 312 also stores the received file system calls 152 and received files in a log 602. In particular, the log serves as a cache to store received file system calls 152 and, in some embodiments, may also store the complete or portions of the files that are associated with the file system calls 152. In general, the log can be used to reinitiate a file-related session when, for example, communication is interrupted or when a storage system fails. For example, if a storage system fails during the application of file system calls, then the log 602 can be accessed to identify the file system calls that have been received but not applied. When the storage system is later operational, such identified file system calls may then be applied again. In another example, the log 602 may store a portion of a file that has been received. If the transmission of the file is interrupted, the complete file does not need to be retransmitted again. Instead, the log 602 can be accessed to identify the portion of the file that has been received. When transmission is reestablished, the download (or transmission) can restart at a file offset where the last transmission had terminated.

The post processing module 314 may then apply to the received file system calls by forwarding the file system calls 152 to the virtual file system 306. In some embodiments, the post processing module 314 may also apply the file system calls 152 based on a variety policies. An example of a policy is conflict resolution where multiple file system calls 152, which are received from one or multiple remote data centers, operate on the same file object. These file system calls 152 may conflict with each other and, in some embodiments, a user may specify in a policy that only the latest file system call is applied. As discussed earlier, a message or a file system call included in the message may include a value that identifies a priority assigned to the file system call. Examples of such a value include a timestamp, a sequence number, or other values. The value may be included or embedded in an extension of a file name, an attribute associated with the file name, or at other locations associated with the message or file system calls.

If a timestamp is used, a policy may, for example, define that only the most recent file system call from a set of identical file system calls, as identified by comparing the timestamps, is applied. If a sequence number is used, another policy may define that only the file system call from a set of identical file system calls with the highest sequence number is applied. This sequence number is synchronized between all the remote data centers and is configured to increase with the passage of time. If the sequence number is configured decrease with the passage of time, the policy may define that the file system call with the smallest sequence value is applied.

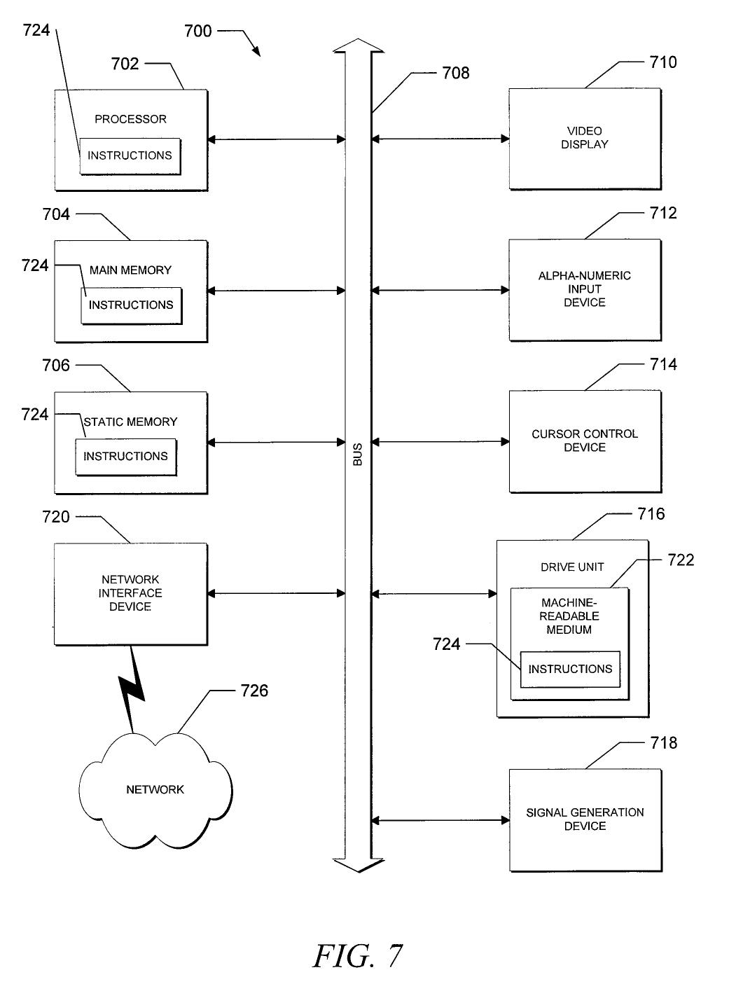

FIG. 7 is a block diagram of a machine in the example form of a processing system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Furthermore, the machine may operate in the capacity of a server or a client machine in server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 700 includes a processor 702 (e.g., a central processing unit (CPU), a graphics processing unit (GPU) or both), a main memory 704, and static memory 706, which communicate with each other via bus 708. The processing system 700 may further include video display unit 710 (e.g., a plasma display, a liquid crystal display (LCD) or a cathode ray tube (CRT)). The processing system 700 also includes an alphanumeric input device 712 (e.g., a keyboard), a user interface (UI) navigation device 714 (e.g., a mouse), a disk drive unit 716, signal generation device 718 (e.g., a speaker), and network interface device 720.

The disk drive unit 716 includes machine-readable medium 722 on which is stored one or more sets of instructions and data structures (e.g., software 724) embodying or utilized by any one or more of the methodologies or functions described herein. The software 724 may also reside, completely or at least partially, within main memory 704 and/or within processor 702 during execution thereof by processing system 700, main memory 704, and processor 702 also constituting machine-readable, tangible media.

Software 724 may further be transmitted or received over network 726 via network interface device 720 utilizing any one of a number of well-known transfer protocols (e.g., HTTP).

While the invention(s) is (are) described with reference to various implementations and exploitations, it will be understood that these embodiments are illustrative and that the scope of the invention(s) is not limited to them. In general, techniques for synchronizing file objects may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A method comprising:
intercepting a file system call from a virtual file system, the file system call being associated with a file at a data center, the data center being in communication with a remote data center; and
transmitting the file system call to the remote data center to synchronize a copy of the file at the remote data center with the file at the data center.

2. The method of claim 1, wherein the file system call is further intercepted in a kernel of an operating system that is hosted at a processing system associated with the data center.

3. The method of claim 1, wherein the file system call is transmitted in a message to the remote data center, the method further comprising attaching a timestamp to the message.

4. The method of claim 1, further comprising transmitting a file associated with the file system call to the remote data center.

5. The method of claim 1, wherein the file system call is a write operation.

6. The method of claim 1, wherein the file system call is a delete operation.

7. Software encoded in one or more computer-readable media and when executed operable to:
intercept a file system call called by a virtual file system to operate on a file object at a data center, the data center configured to be in communication with a remote data center; and
transmit the file system call to the remote data center to synchronize a copy of the file object at the remote data center with the file object at the data center.

8. The software of claim 7, wherein the virtual file system is hosted at the data center.

9. The software of claim 7, wherein the virtual file system is included in a kernel of an operating system.

10. The software of claim 7, wherein the virtual file system is a file system interface.

11. The software of claim 7, wherein the file system call is transmitted in a message to the remote data center, the software when executed further operable to attach a sequence number to the message.

12. The software of claim 7, wherein the file object is a file.

13. The software of claim 7, wherein the file object is a directory.

14. The software of claim 7, wherein the file object is an inode.

15. An apparatus comprising:
at least one processor; and
a memory in communication with the at least one processor, the memory being configured to store a capture module, a virtual file system, and an export module that are executable by the at least one processor,
the capture module having instructions, that when executed by the at least one processor, cause operations to be performed, comprising intercepting a file system call from the virtual file system, the file system call being associated with a file object at a data center that is in communication with a remote data center, the apparatus being associated with the data center, and
the export module having instructions, that when executed by the at least one processor, cause operations to be performed, comprising transmitting the file system call to the remote data center to synchronize a copy of the file object at the remote data center with the file object at the data center.

16. The apparatus of claim 15, wherein the memory is further configured to store an import module that is executable by the at least one processor, the import module having instructions, that when executed by the at least one processor, cause operations to be performed, comprising:
receiving a further file system call from the remote data center; and
storing the further file system call in a log.

17. The apparatus of claim 15, wherein the memory is further configured to store a post processing module that is executable by the at least one processor, the post processing module having instructions, that when executed by the at least one processor, cause operations to be performed, comprising:
receiving a further file system call from the remote data center; and
applying the further file system call at the data center.

18. The apparatus of claim 15, wherein the apparatus is an application server.

19. The apparatus of claim 15, wherein the capture module is included in a kernel of an operating system.

20. A method comprising:
receiving a message, at a data center, from a remote data center, the message including a file system call called by a virtual file system hosted at the remote data center, and the file system call configured to operate on a file object at the remote data center; and
applying the file system call to a copy of the file object at the data center to synchronize the file object at the remote data center with the copy of the file object at the data center.

21. An apparatus comprising:
a means for intercepting a file system call from a virtual file system, the file system call being associated with a file at a data center, the data center being in communication with a remote data center; and
an export module to transmit the file system call to the remote data center to synchronize a copy of the file at the remote data center with the file at the data center.
